(19) United States
(12) Patent Application Publication
(10) Pub. No.: US 2025/0296324 A1
(43) Pub. Date: Sep. 25, 2025

(54) LIQUID EJECTION HEAD AND LIQUID EJECTION APPARATUS

(71) Applicant: RISO Technologies Corporation, Tokyo (JP)

(72) Inventor: Sota HARADA, Mishima Shizuoka (JP)

(21) Appl. No.: 18/970,851

(22) Filed: Dec. 5, 2024

(30) Foreign Application Priority Data
Mar. 19, 2024 (JP) 2024-043847

(51) Int. Cl. B41J 2/045

(52) U.S. Cl. CPC B41J 2/04588; B41J 2/04573

(57) ABSTRACT

A liquid ejection head includes nozzles, pressure chambers communicating with the nozzles, volumes thereof being varied to eject liquid through the nozzles, an actuator varying the volumes according to drive waveforms respectively applied to the chambers, a signal processing circuit configured to, upon receipt of an instruction, acquire first data indicating first waveforms and second data indicating second waveforms, and determine third waveforms based on differences between the first and second waveforms, the third and second waveforms being applied to the chambers at first and second timings, and a drive circuit configured to output the drive waveforms generated by the signal processing circuit to the pressure chambers. One of the third drive waveforms is different from or identical to a corresponding one of the first drive waveforms depending on whether said one of the first drive waveforms and a corresponding one of the second drive waveforms match a predetermined pattern.

### CROSS-REFERENCE TO RELATED APPLICATION

This application is based upon and claims the benefit of priority from Japanese Patent Application No. 2024-043847, filed on Mar. 19, 2024, the entire contents of which are incorporated herein by reference.

### FIELD

Embodiments described herein relate generally to a liquid ejection head and a liquid ejection apparatus.

### BACKGROUND

In a related-art method of supplying an ejection control signal to a liquid ejection head such as an inkjet head, data about settings such as drive waveforms is transferred to a head drive circuit, and then print image data is sequentially transferred to the head drive circuit in accordance with a print synchronization signal.

Along with an increase in speed and resolution, influences such as crosstalk occur depending on whether a droplet has been ejected from the same nozzle immediately before or whether a surrounding nozzle has ejected a droplet. In particular, when a delay between cycles, which is an interval between lines, is shorter due to the increase in speed, an influence of a residual vibration and a meniscus vibration becomes greater.

For example, in a state where a vibration that occurs when droplets are ejected in a prior line remains, droplets are ejected in a next line. It is also known that the vibration can be attenuated by a cancel pulse after an ejection pulse. However, the meniscus vibration is attenuated slower than the residual vibration, and an influence thereof appears to be remarkable along with the increase in speed.

An initial state of the meniscus of each line influences an ejection amount and ejection performance such as an ejection speed of droplets. Accordingly, an ejection amount of a first line which is not driven immediately before is smaller than that of a second line and subsequent lines, and there is a tendency that the ejection speed is faster, and a print quality deteriorates.

Therefore, there is a method in which the liquid ejection head performs non-ejection driving by inputting a non-ejection waveform, such as precursor driving, boost driving, or preliminary driving, in a non-driving line. Since the meniscus changes after the non-ejection driving, the print quality of the liquid ejection head is improved. However, the non-ejection driving increases power consumption since the non-ejection driving is generally performed periodically or in a certain period. For example, there is a known method of searching image data for pixels to transition from non-ejection data to ejection data and adding non-ejection driving data to the image data. However, this method requires additional steps to be performed by a user of the printer or its software, and thus usability deteriorates.

### BRIEF DESCRIPTION OF THE DRAWINGS

FIG. 1 is a block diagram showing a configuration of a liquid ejection recording apparatus including a liquid ejection head according to an embodiment.

FIG. 2 is a block diagram showing a configuration of a signal processing circuit.

FIG. 3 is a block diagram showing a configuration of a head drive circuit.

FIG. 4 is a diagram showing an example of a truth table of a print data conversion process performed by the signal processing circuit.

FIG. 5 is a diagram showing an example of setting data for determining a drive waveform based on print data.

FIG. 6 is a diagram showing another example of the truth table.

FIG. 7 is a block diagram showing a configuration of a head drive circuit according to another embodiment.

FIG. 8 is a diagram showing an example of setting data for determining a drive waveform based on print data.

### DETAILED DESCRIPTION

In general, according to one embodiment, it is possible to provide a liquid ejection head and a liquid ejection apparatus capable of generating driving waveforms without deteriorating ejection quality and usability.

According to one embodiment, a liquid ejection head comprises a plurality of nozzles through which liquid is ejected; a plurality of pressure chambers that respectively communicate with the nozzles, volumes of the pressure chambers being varied to eject the liquid through the corresponding nozzles; an actuator configured to vary the volumes of the pressure chambers independently according to drive waveforms respectively applied to the pressure chambers; a signal processing circuit configured to: upon receipt of an instruction to eject the liquid, acquire first waveform data indicating first drive waveforms for the pressure chambers and second waveform data indicating second drive waveforms for the pressure chambers, and determine third drive waveforms for the pressure chambers based on differences between the first and second drive waveforms, the third drive waveforms being applied to the pressure chambers at a first timing and the second drive waveforms are applied to the pressure chambers at a second timing that is different from the first timing; and a drive circuit configured to output the drive waveforms generated by the signal processing circuit to the pressure chambers. One of the third drive waveforms is different from or identical to a corresponding one of the first drive waveforms depending on whether said one of the first drive waveforms and a corresponding one of the second drive waveforms match a predetermined pattern.

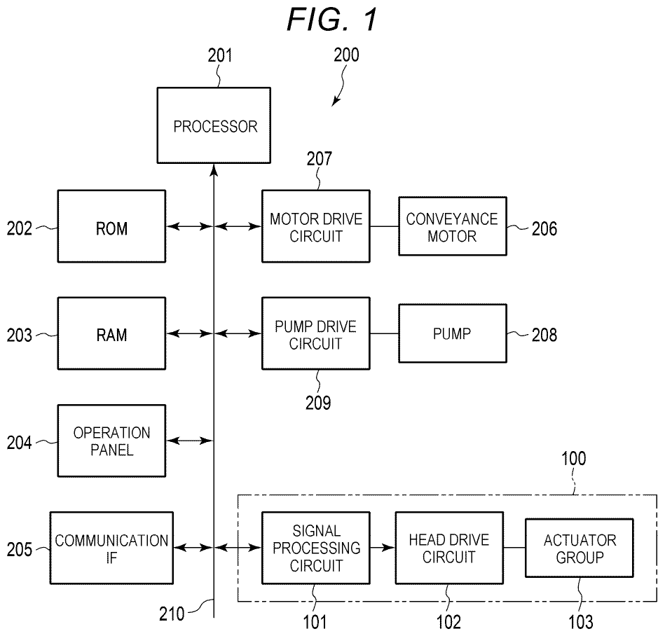

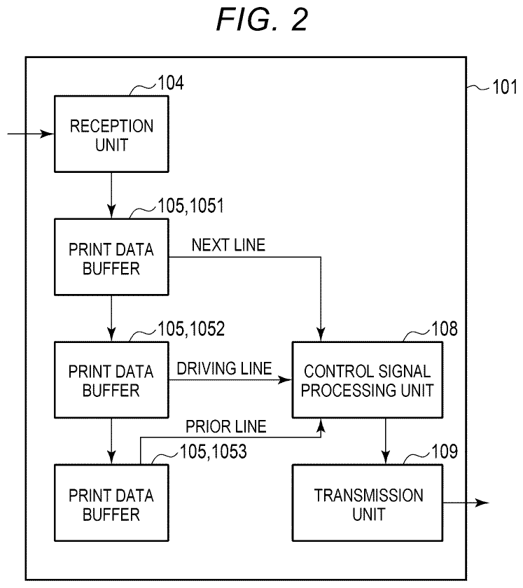

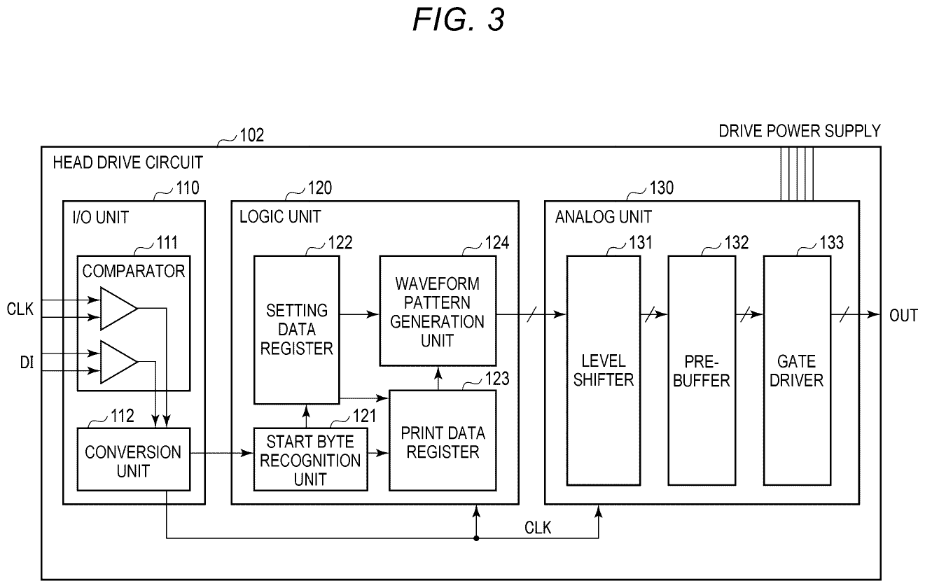

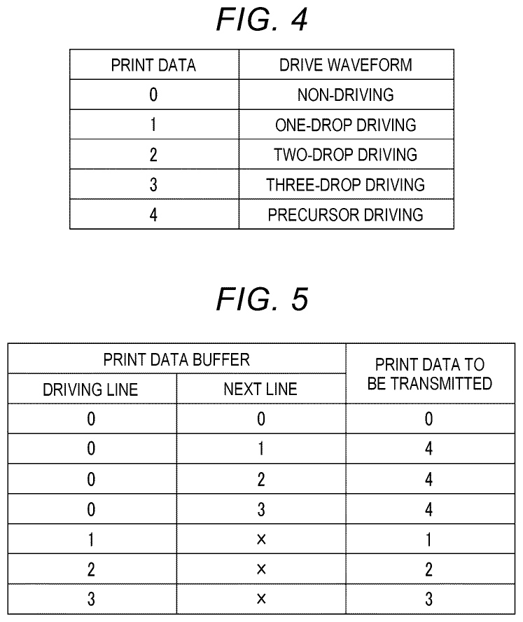

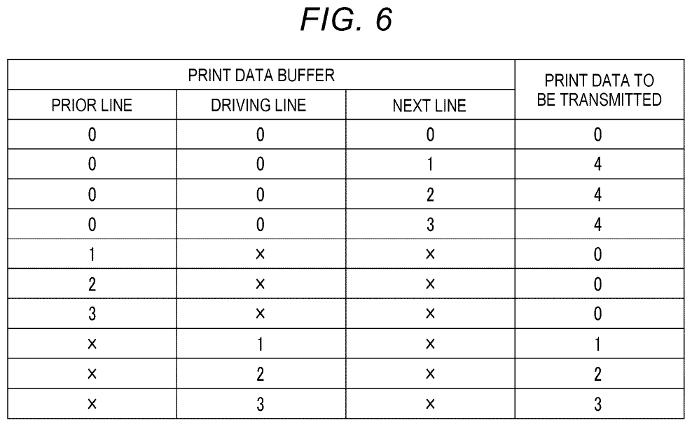

A liquid ejection head 100 and a liquid ejection apparatus 200 including the liquid ejection head 100 according to embodiments will be described below with reference to FIGS. 1 to 6. FIG. 1 is a block diagram showing a configuration of the liquid ejection apparatus 200 including the liquid ejection head 100 according to an embodiment. FIG. 2 is a block diagram showing a configuration of a signal processing circuit 101 of the liquid ejection head 100. FIG. 3 is a block diagram showing a configuration of a head drive circuit 102 of the liquid ejection head 100. FIG. 4 is a diagram showing an example of a truth table of a print data conversion process performed by a control signal processing unit 108 of the signal processing circuit 101 of the liquid ejection head 100. FIG. 5 is a diagram showing an example of setting data for determining a drive waveform based on print data of the liquid ejection head 100. FIG. 6 is a diagram showing another example of the truth table of the print data conversion process performed by the control signal processing unit 108 of the signal processing circuit 101 of the liquid ejection head 100.

The liquid ejection head 100 is, for example, a share-mode inkjet head that ejects ink as a liquid onto a recording or printing medium such as a paper sheet. The liquid ejection apparatus 200 including the liquid ejection head 100 is a recording or printing apparatus such as an inkjet printer that performs printing by ejecting ink onto a recording medium such as a paper sheet.

The liquid ejection apparatus 200 includes the liquid ejection head 100, a processor 201, a read only memory (ROM) 202, a random access memory (RAM) 203, an operation panel 204, a communication interface (IF) 205, a conveyance motor 206, a motor drive circuit 207, a pump 208, and a pump drive circuit 209.

In addition, the liquid ejection apparatus 200 includes a bus line 210 such as an address bus or a data bus. The liquid ejection head 100, the processor 201, the ROM 202, the RAM 203, the operation panel 204, the communication interface 205, the motor drive circuit 207, and the pump drive circuit 209 are connected to the bus line 210 directly or via an input and output circuit, and can transmit data to and receive data from each other.

The liquid ejection head 100 includes the signal processing circuit 101, the head drive circuit 102, and a group of actuators 103 (hereinafter also referred to as the actuator group 103).

The signal processing circuit 101 is connected to the processor 201, the ROM 202, and the RAM 203 via the bus line 210, for example. The signal processing circuit 101 is, for example, a logic circuit capable of processing a communication signal, and is a microcontroller, an FPGA (field programmable gate array), an ASIC (application-specific integrated circuit), or the like. As an example of the signal processing circuit 101, a reception unit and a transmission unit may have a configuration of one signal line or a configuration of two LVDS (low-voltage differential signaling) signal lines. The signal processing circuit 101 outputs print data for determining a waveform pattern generated by the head drive circuit 102 to the head drive circuit 102. The signal processing circuit 101 may receive and transmit a clock signal in addition to a print data signal in order to process the communication signal. When received print data in a plurality of lines matches a print pattern of a specific algorithm, the signal processing circuit 101 transmits, to the head drive circuit 102, predetermined print data in a specific line as a non-ejection drive waveform which is a print pattern different from an original print pattern, that is, a precursor waveform in an example described below.

For example, the signal processing circuit 101 includes a reception unit 104, a plurality of print data buffers 105, the control signal processing unit 108, and a transmission unit 109. The signal processing circuit 101 performs a print data conversion process for converting print data into different print data based on an algorithm of the received print data in the plurality of lines.

The reception unit 104 receives the print data in the plurality of lines transmitted from the processor 201, the ROM 202, the RAM 203, and the like. The reception unit 104 transmits the received print data in the plurality of lines to the print data buffers 105.

The plurality of print data buffers 105 are provided. When corresponding print data is received, the print data buffer 105 outputs the print data to the control signal processing unit 108, and when non-corresponding print data is received, the print data buffer 105 outputs the print data to other print data buffers 105. For example, the number of the print data buffers 105 is set to be the same as the number of lines used in the print data conversion process for replacing the print data with the non-ejection drive waveform by the signal processing circuit 101. For example, two or three print data buffers 105 are provided, and when print data in one corresponding line is received, the print data is output to the control signal processing unit 108, and when print data in a non-corresponding line is received, the print data in the non-corresponding line is output to the print data buffer 105 corresponding to a next line. In the following description, the three print data buffers 105 will be described according to an order of a plurality of lines, the first print data buffer 105 may be referred to as a print data buffer 1051, the second print data buffer 105 may be referred to as a print data buffer 1052, and the third print data buffer 105 may be referred to as a print data buffer 1053. The print data buffers 105 each function as a memory for storing print data in a corresponding line.

For example, in an example having two print data buffers 105, the print data buffer 1051 outputs print data in one line after a driving line to the control signal processing unit 108, and the print data buffer 1052 outputs print data in the driving line to the control signal processing unit 108. Here, the driving line is a line for driving the actuator or the pressure chamber, in other words, a line for determining an operation of the head drive circuit 102. In an example having three print data buffers 105, for example, the print data buffer 1051 outputs print data in one line after a driving line to the control signal processing unit 108, the print data buffer 1052 outputs print data in the driving line to the control signal processing unit 108, and the print data buffer 1053 outputs print data to be driven or driven one line prior to the driving line to the control signal processing unit 108.

The control signal processing unit 108 functions as, for example, a memory for storing a predetermined print pattern. Further, the control signal processing unit 108 receives the print data in the line transmitted from the print data buffers 105, and determines whether the print data matches the print pattern of the specific algorithm. Then, when the print data in the line transmitted from the print data buffers 105 matches the print pattern of the specific algorithm, the control signal processing unit 108 outputs, to the transmission unit 109, a precursor, non-ejection waveform, which is an example of print data different from the print data in the line to be driven. When the print data in the line transmitted from the print data buffers 105 does not match the print pattern of the specific algorithm, the control signal processing unit 108 outputs, to the transmission unit 109, print data same as the print data in the line to be driven.

The transmission unit 109 outputs the print data received from the control signal processing unit 108 to the head drive circuit 102.

The head drive circuit 102 is a circuit that generates a drive signal including an expansion pulse for expanding volumes of a plurality of pressure chambers of the actuator group 103 and a contraction pulse for contracting the volumes of the plurality of pressure chambers. The head drive circuit 102 generates a drive waveform as a drive signal based on the print data, and drives the actuator group 103 of the liquid ejection head 100. The actuator group 103 expands and contracts the pressure chambers that accommodate ink, and causes ink droplets to be ejected from nozzles communicating with the pressure chambers. Accordingly, the liquid ejection head 100 ejects the ink onto the recording medium conveyed by a conveyance mechanism, and prints an image or the like on the recording medium.

As shown in FIG. 3, the head drive circuit 102 includes an I/O unit 110, a logic unit 120, and an analog unit 130.

The I/O unit 110 is a circuit that includes a comparator 111 and a serial-parallel conversion unit 112. In the drawings, the “serial-parallel conversion unit” is abbreviated as a “conversion unit”.

The comparator 111 receives a clock signal CLK and a data signal DI with LVDS. The data signal DI includes print data, setting data, and the like. The comparator 111 outputs data of the clock signal CLK and data of the data signal DI to the serial-parallel conversion unit 112.

The serial-parallel conversion unit 112 converts serial format data received from the comparator 111 into parallel format data. The data of the data signal DI is acquired at a timing when the clock signal CLK rises. Specifically, at a timing when the clock signal CLK changes from 0 to 1, values (0 or 1) of the setting data and the print data included in the data signal DI are acquired. The serial-parallel conversion unit 112 outputs the parallel format data of the data signal DI to the logic unit 120. In addition, the serial-parallel conversion unit 112 outputs the data of the clock signal CLK to the logic unit 120 and the analog unit 130.

The logic unit 120 is a circuit that includes a start byte recognition unit 121, a setting data register 122, a print data register 123, and a waveform pattern generation unit 124.

The start byte recognition unit 121 recognizes a start byte for the parallel format data of the data signal DI received from the serial-parallel conversion unit 112, and separates the data into the setting data and the print data. The start byte recognition unit 121 outputs the setting data to the setting data register 122 and outputs the print data to the print data register 123.

The setting data register 122 stores the setting data received from the start byte recognition unit 121.

The print data register 123 stores the print data received from the start byte recognition unit 121.

The waveform pattern generation unit 124 acquires the setting data from the setting data register 122, acquires the print data from the print data register 123, and generates a waveform pattern as a drive signal based on the setting data and the print data. The waveform pattern generation unit 124 outputs the generated waveform pattern to the analog unit 130.

That is, the analog unit 130 is a drive waveform generation circuit that generates a drive waveform based on the waveform pattern. The analog unit 130 includes a level shifter 131, a pre-buffer 132, and a gate driver 133.

The level shifter 131 converts the waveform pattern received from the waveform pattern generation unit 124 into a high voltage. The level shifter 131 outputs the waveform pattern converted into a high voltage to the pre-buffer 132.

The pre-buffer 132 appropriately amplifies and shapes the waveform pattern received from the level shifter 131. The pre-buffer 132 outputs the appropriately amplified and shaped waveform pattern to the gate driver 133.

The gate driver 133 outputs a drive waveform for driving the actuator group 103 of the liquid ejection head 100 by controlling ON and OFF of a plurality of switch elements of the gate driver 133 based on the waveform pattern received from the pre-buffer 132. That is, the gate driver 133 outputs the drive waveform based on the waveform pattern. For example, the switch element is a MOSFET, and the gate driver 133 controls ON and OFF of the MOSFET by applying a control signal (i.e., a gate voltage) to a gate of the MOSFET.

The actuator group 103 includes a plurality of actuators. The actuator is a drive element for expanding and contracting the pressure chamber that accommodates ink to eject ink droplets from the nozzle communicating with the pressure chamber. For example, the actuator is a piezoelectric drive element made of lead zirconate titanate (PZT). The actuator of the actuator group 103 is driven according to a drive signal supplied from the head drive circuit 102 to expand and contract the pressure chamber, to eject the droplets from the nozzle by changing the volume of the pressure chamber.

The processor 201 controls the other components and performs various functions of the liquid ejection apparatus 200 according to an operating system and/or an application program. The processor 201 is, for example, a central processing unit (CPU).

The ROM 202 stores the above operating system and application program. The ROM 202 may store data necessary for the processor 201 to execute processes for controlling the components of the liquid ejection apparatus 200.

The RAM 203 stores data necessary for the processor 201 to execute processes. The RAM 203 is also used as a work area where information is appropriately rewritten by the processor 201. The work area includes an image memory in which print data is loaded.

The operation panel 204 includes an operation unit and a display unit such as a liquid-crystal display (LCD). The operation unit is provided with function keys such as a power key, a paper feed key, and an error release key. The display unit can display various states of the liquid ejection apparatus 200.

The communication interface 205 is an interface circuit that receives the print data from a client terminal connected via a network such as a local area network (LAN). For example, when an error occurs in the liquid ejection apparatus 200, the communication interface 205 transmits a signal indicating the error to the client terminal.

The motor drive circuit 207 controls driving of the conveyance motor 206. The conveyance motor 206 functions as a drive source of the conveyance mechanism that conveys a recording medium such as printing paper. When the conveyance motor 206 is started, the conveyance mechanism starts conveying the recording medium. The conveyance mechanism conveys the recording medium to a printing position of the liquid ejection head 100. The conveyance mechanism discharges the recording medium after printing from a discharge port (not shown) to an outside of the liquid ejection apparatus 200.

The pump drive circuit 209 controls driving of the pump 208. When the pump 208 is driven, ink in an ink tank (not shown) is supplied to the liquid ejection head 100.

Next, with reference to FIGS. 4 and 5, an example of a method for generating a drive waveform based on print data in two lines using two print data buffers 1051 and 1052 in the signal processing circuit 101 and the head drive circuit 102 of the liquid ejection head 100 will be described.

For example, as shown in FIG. 4, print data and a drive waveform for the print data are stored in the setting data register 122. For example, the print data “0” is a non-driving waveform pattern, the print data “1” is a waveform pattern for one-drop driving for ejecting one droplet, the print data “2” is a waveform pattern for two-drop driving for ejecting two droplets, the print data “3” is a waveform pattern for three-drop driving for ejecting three droplets, and the print data “4” is a waveform pattern for precursor driving as a non-ejection waveform. In FIG. 5, “x” is a Don't Care symbol regardless of a value of the print data, and is any one of 0 to 3. The values of the print data input to the signal processing circuit 101 are 0 to 3.

When the reception unit 104 receives print data in two lines, the signal processing circuit 101 inputs the print data in two lines from the reception unit 104 to the print data buffer 1051. The print data buffer 1051 outputs print data in a next line to the control signal processing unit 108 as a corresponding line, and outputs print data in a line to be driven to the print data buffer 1052 as a non-corresponding line. The print data buffer 1052 outputs the print data in the line to be driven to the control signal processing unit 108 as a corresponding line.

When the print data received from the print data buffer 1051 and the print data received from received from the print data buffer 1052 match the print pattern of the specific algorithm, the control signal processing unit 108 performs the print data conversion process of outputting, to the transmission unit 109, print data different from the print data in the line to be driven. For example, in order to prevent a phenomenon in which an ejection volume decreases when a state changes from a non-driving state to an ejecting state, a case where the driving line is non-driving and the next line ejects droplets is determined as the specific algorithm, and in the driving line, print data is output to the transmission unit 109 to drive a precursor waveform that does not eject droplets but is not a non-drive waveform as a non-ejection waveform. Specifically, since the setting data of the setting data register 122 is set to a waveform pattern of the precursor driving when the print data is “4”, the control signal processing unit 108 outputs the print data “4” to the transmission unit 109 such that the print data in the driving line corresponds to the precursor driving when the print data is the print data “0” which is non-driving in the driving line and matches any one of the patterns “1”, “2”, and “3” which are the print data for ejecting liquid droplets in the next line, as shown in the truth table of the print data conversion process in FIG. 5. Further, as shown in FIG. 5, when the print data is “0” which is non-driving in the driving line and does not match any one of the patterns “1”, “2”, and “3” which are the print data for ejecting liquid droplets in the next line, that is, when the print data in the driving line is “0” and the print data in the next line is “0” or the print data in the driving line is “1”, “2”, and “3”, the control signal processing unit 108 outputs the print data in the driving line to the transmission unit 109.

Then, when the head drive circuit 102 acquires the print data in the driving line from the transmission unit 109, the waveform pattern generation unit 124 acquires the setting data from the setting data register 122 and acquires the print data from the print data register 123. Then, the waveform pattern generation unit 124 generates a waveform pattern as a drive waveform based on the setting data and the print data in the driving line output from the signal processing circuit 101. In this manner, the signal processing circuit 101 and the head drive circuit 102 of the liquid ejection head 100 generate a drive waveform based on the print data in the driving line and the print data in one line after the driving line using print data in two lines (i.e., in the two print data buffers 1051 and 1052).

The print data conversion process described above is performed by the head drive circuit 102, the print data register 123 that outputs the print data in the driving line to the waveform pattern generation unit 124, and the waveform pattern generation unit 124, which are implemented by a plurality of integrated circuits, for example, two ICs of the signal processing circuit 101 and the head drive circuit 102.

Next, with reference to FIGS. 4 and 6, another example of the method for generating a drive waveform based on print data in three lines using three print data buffers 1051, 1052, and 1053 in the signal processing circuit 101 and the head drive circuit 102 of the liquid ejection head 100 will be described.

When the reception unit 104 receives print data in three lines, the signal processing circuit 101 inputs the print data in three lines from the reception unit 104 to the print data buffer 1051. The print data buffer 1051 outputs print data in a next line to the control signal processing unit 108 as a corresponding line, and outputs print data in a line to be driven and print data in one line prior to the line to be driven to the print data buffer 1052 as two non-corresponding lines. The print data buffer 1052 outputs the print data in the line to be driven to the control signal processing unit 108 as a corresponding line, and outputs the print data in the prior line to the print data buffer 1053 as a non-corresponding line. The print data buffer 1053 outputs the print data in the prior line to the control signal processing unit 108 as a corresponding line.

When the print data received from the print data buffer 1051, the print data received from the print data buffer 1052, and the print data received from the print data buffer 1053 match the print pattern of the specific algorithm, the control signal processing unit 108 outputs, to the transmission unit 109, print data different from the print data in the line to be driven. For example, in order to prevent the phenomenon in which an ejection volume decreases when a state changes from a non-driving state to an ejecting state, a case where the prior line and the driving line are non-driving and the next line ejects droplets is determined as the specific algorithm, and in the driving line, print data is output to the transmission unit 109 to drive a precursor waveform that does not eject droplets but is not a non-drive waveform as a non-ejection waveform. Specifically, the setting data of the setting data register 122 is set to a waveform pattern of the precursor driving when the print data is “4”. Therefore, the control signal processing unit 108 outputs the print data “4” to the transmission unit 109 such that the print data in the driving line corresponds to the precursor driving when the print data is the print data “0” which is non-driving in both the prior line and the driving line and matches any one of the patterns “1”, “2”, and “3” which are the print data for ejecting liquid droplets in the next line, as shown in the truth table of the print data conversion process in FIG. 6. Further, as shown in FIG. 6, when the print data is “0” which is non-driving in the driving line and does not match any one of the patterns “1”, “2”, and “3” which are the print data for ejecting liquid droplets in the next line, that is, when the print data in the driving line is “0” and the print data in the next line is “0” or the print data in the driving line is “1”, “2”, and “3”, the control signal processing unit 108 outputs the print data in the driving line to the transmission unit 109.

Accordingly, when only one line of driving lines is non-driving, that is, when the print data is in the order of driving, non-driving, and driving in the driving line and lines prior to and after the driving line, if precursor driving is set for the driving line, the print data is in the order of driving, precursor driving, and driving, and the print quality may deteriorate. For this reason, in the present example, as a countermeasure against the deterioration of the print quality, only when the driving line and one line prior to the driving line are continuously non-driving, that is, the driving line and lines prior to and after the driving line are the print data in the order of non-driving, non-driving, and driving, the precursor driving is performed in the driving line. That is, the control signal processing unit 108 sets the print data in the order of non-driving, precursor driving, and driving in the driving line and the lines prior to and after the driving line, and does not perform the conversion process when only one line of the driving line and the lines prior to and after the driving line is non-driving.

Then, when the head drive circuit 102 acquires the print data in the driving line from the transmission unit 109, the waveform pattern generation unit 124 acquires the setting data from the setting data register 122 and acquires the print data from the print data register 123. Then, the waveform pattern generation unit 124 generates a waveform pattern as a drive waveform based on the setting data and the print data in the driving line output from the signal processing circuit 101. In this manner, the signal processing circuit 101 and the head drive circuit 102 of the liquid ejection head 100 generate a drive waveform based on the print data in the driving line, the print data in one line prior to the driving line, and the print data in one line after the driving line using the print data in three lines (the three print data buffers 1051, 1052, and 1053).

As described above, when print data in a plurality of lines matches a specific pattern, the liquid ejection head 100 can perform, by the signal processing circuit 101, driving using print data different from print data in a driving line. Therefore, the liquid ejection head 100 can generate a non-ejection waveform based on the print data in the plurality of lines without deteriorating usability while preventing an increase in power consumption.

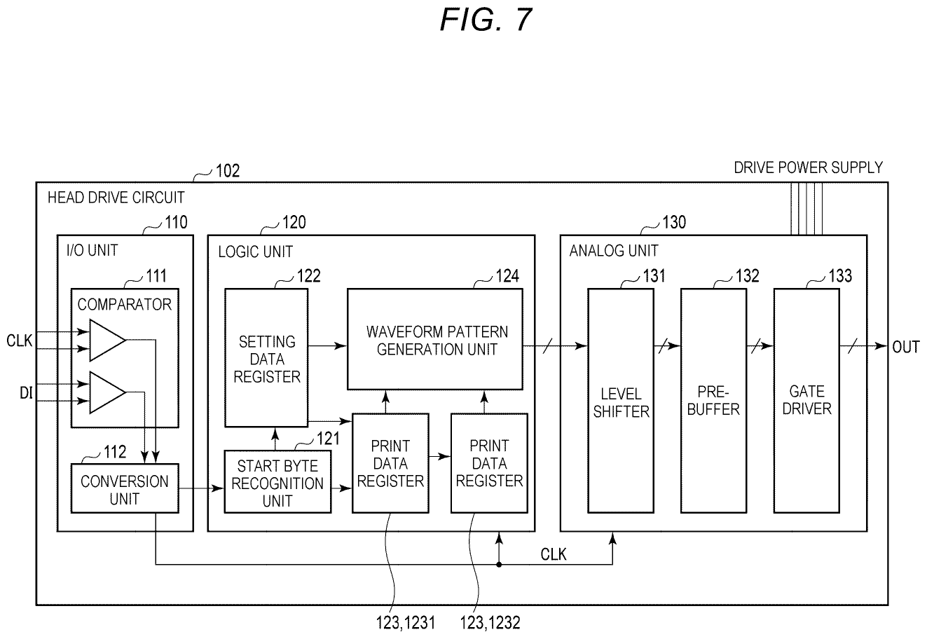

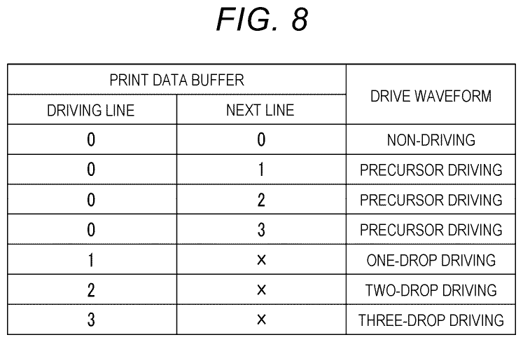

The embodiments described above are mere examples, and the disclosure is not limited thereto. For example, in the above example, the liquid ejection head 100 includes the signal processing circuit 101, and the signal processing circuit 101 performs the print data conversion process of converting the print data into different print data based on the algorithm of the received print data in a plurality of lines, but the disclosure is not limited thereto. For example, the liquid ejection head 100 may not include the signal processing circuit 101, and the head drive circuit 102 may perform the print data conversion process. The head drive circuit 102 of the liquid ejection head 100 having no signal processing circuit 101 according to another embodiment will be described below with reference to FIGS. 7 and 8. Instead of the signal processing circuit 101, the head drive circuit 102 of the liquid ejection head 100 performs a print data conversion process in which the waveform pattern generation unit 124 having the same function as the control signal processing unit 108 converts print data into different print data based on received print data in a plurality of lines.

The head drive circuit 102 according to another embodiment shown in FIG. 7 is different from the head drive circuit 102 shown in FIG. 3 in the number of print data registers 123. That is, in the head drive circuit 102 shown in FIG. 7, the number of the print data registers 123 is equal to the number of lines of the print data for performing the print data conversion process. For example, in the example in FIGS. 7 and 8, since the head drive circuit 102 of the liquid ejection head 100 performs the print data conversion process based on print data in a driving line and print data in one line after the driving line, two print data registers 123 are provided.

That is, in the head drive circuit 102 according to another embodiment, as shown in FIG. 7, the waveform pattern generation unit 124 determines a drive waveform by referring to the print data in one line after the driving line in addition to print data in a line to be driven. For example, the print data register 123 includes a print data register 1231 for referring to the print data in the driving line and a print data register 1232 for referring to the print data in one line after the driving line.

The control signal processing unit 108 of the signal processing circuit 101 referring to the above plurality of pieces of print data is a circuit included in the waveform pattern generation unit 124. Therefore, the head drive circuit 102, the print data register 1231 that outputs the print data in one line after the driving line to the waveform pattern generation unit 124, the print data register 1232 that outputs the print data in the driving line to the waveform pattern generation unit 124, and the waveform pattern generation unit 124 serving as a signal processing circuit are constituted by a same integrated circuit. For example, the print data register 1231 outputs the print data in one line after the driving line to the waveform pattern generation unit 124, and outputs the print data in the driving line to the print data register 1232. The print data register 1232 outputs the print data in the driving line to the waveform pattern generation unit 124. Then, the waveform pattern generation unit 124 acquires setting data from the setting data register 122 shown in FIG. 8, acquires print data from the print data registers 1231, 1232, and generates a waveform pattern as a drive signal based on the predetermined setting data and the print data. The print data registers 123 each function as a memory for storing print data in a corresponding line.

When print data in a plurality of lines matches a specific pattern, the liquid ejection head 100 using the head drive circuit 102 according to another embodiment can perform driving using print data different from print data in a driving line. Therefore, the liquid ejection head 100 can generate a non-ejection waveform based on the print data in the plurality of lines without deteriorating usability while preventing an increase in power consumption.

According to the liquid ejection head in at least one embodiment described above, when print data in a plurality of lines matches a specific pattern, driving is performed using print data different from the print data in the driving line, so that it is possible to obtain a non-ejection waveform based on the print data in the plurality of lines without deteriorating usability while preventing an increase in power consumption.

While certain embodiments have been described, the embodiments have been presented by way of example only and are not intended to limit the scope of the disclosure. These novel embodiments can be implemented in various other forms, and various omissions, substitutions, and modifications can be made without departing from the gist of the disclosure. The embodiments and the modifications thereof are included in the scope and the gist of the disclosure, and are included in the scope of the disclosure disclosed in the claims and equivalents thereof.

What is claimed is:

1. A liquid ejection head comprising:
a plurality of nozzles through which liquid is ejected;
a plurality of pressure chambers that respectively communicate with the nozzles, volumes of the pressure chambers being varied to eject the liquid through the corresponding nozzles;
an actuator configured to vary the volumes of the pressure chambers independently according to drive waveforms respectively applied to the pressure chambers;
a signal processing circuit configured to:
upon receipt of an instruction to eject the liquid, acquire first waveform data indicating first drive waveforms for the pressure chambers and second waveform data indicating second drive waveforms for the pressure chambers, and
determine third drive waveforms for the pressure chambers based on differences between the first and second drive waveforms, wherein the third drive waveforms are applied to the pressure chambers at a first timing and the second drive waveforms are applied to the pressure chambers at a second timing that is different from the first timing; and
a drive circuit configured to output the drive waveforms generated by the signal processing circuit to the pressure chambers, wherein
one of the third drive waveforms is different from or identical to a corresponding one of the first drive waveforms depending on whether said one of the first drive waveforms and a corresponding one of the second drive waveforms match a predetermined pattern.

2. The liquid ejection head according to claim 1, wherein
the first timing corresponds to a timing for ejecting the liquid next.

3. The liquid ejection head according to claim 2, wherein
the second timing corresponds to a timing for ejecting the liquid immediately after the first timing.

4. The liquid ejection head according to claim 2, wherein
the second timing corresponds to a timing for ejecting the liquid immediately before the first timing.

5. The liquid ejection head according to claim 1, wherein
the signal processing circuit is further configured to:
upon receipt of the instruction, acquire fourth waveform data indicating fourth drive waveforms for the pressure chambers, and
determine the third drive waveforms based on differences between the first, second, and fourth drive waveforms, wherein the fourth drive waveforms are applied to the pressure chambers at a third timing that is different from the first and second timings.

6. The liquid ejection head according to claim 5, wherein
the first timing is after the third timing and before the second timing.

7. The liquid ejection head according to claim 1, wherein
each of the first, second, and third waveforms corresponds to one of: a non-driving waveform, a one-drop driving waveform, a two-drop driving waveform, a three-drop driving waveform, and a precursor driving waveform.

8. The liquid ejection head according to claim 1, wherein
the signal processing circuit includes a first buffer in which the first waveform data is stored and a second buffer in which the second waveform data is stored.

9. The liquid ejection head according to claim 8, wherein
the drive circuit and the signal processing circuit are integrated into a single integrated circuit.

10. The liquid ejection head according to claim 1, wherein
the signal processing circuit includes a receiving circuit through which the first and second waveform data are received and a transmission circuit through which the third drive waveforms are output to the drive circuit.

11. A liquid ejection apparatus for ejecting a liquid onto a medium, comprising:
a conveyer for conveying the medium; and
a liquid ejection head configured to eject the liquid onto the conveyed medium, wherein
the liquid ejection head includes:
a plurality of nozzles through which the liquid is ejected,
a plurality of pressure chambers that respectively communicate with the nozzles, volumes of the pressure chambers being varied to eject the liquid through the corresponding nozzles,
an actuator configured to vary the volumes of the pressure chambers independently according to drive waveforms respectively applied to the pressure chambers,
a signal processing circuit configured to:
upon receipt of an instruction to eject the liquid, acquire first waveform data indicating first drive waveforms for the pressure chambers and second waveform data indicating second drive waveforms for the pressure chambers, and
determine third drive waveforms for the pressure chambers based on differences between the first and second drive waveforms, wherein the third drive waveforms are applied to the pressure chambers at a first timing and the second drive waveforms are applied to the pressure chambers at a second timing that is different from the first timing, and
a drive circuit configured to output the drive waveforms generated by the signal processing circuit to the pressure chambers, and
one of the third drive waveforms is different from or identical to a corresponding one of the first drive waveforms depending on whether said one of the first drive waveforms and a corresponding one of the second drive waveforms match a predetermined pattern.

12. The liquid ejection apparatus according to claim 11, wherein
the first timing corresponds to a timing for ejecting the liquid next.

13. The liquid ejection apparatus according to claim 12, wherein
the second timing corresponds to a timing for ejecting the liquid immediately after the first timing.

14. The liquid ejection apparatus according to claim 12, wherein
the second timing corresponds to a timing for ejecting the liquid immediately before the first timing.

15. The liquid ejection apparatus according to claim 11, wherein
the signal processing circuit is further configured to:
upon receipt of the instruction, acquire fourth waveform data indicating fourth drive waveforms for the pressure chambers, and
determine the third drive waveforms based on differences between the first, second, and fourth drive waveforms, wherein the fourth drive waveforms are applied to the pressure chambers at a third timing that is different from the first and second timings.

16. The liquid ejection apparatus according to claim 15, wherein
the first timing is after the third timing and before the second timing.

17. The liquid ejection apparatus according to claim 11, wherein
each of the first, second, and third waveforms corresponds to one of: a non-driving waveform, a one-drop driving waveform, a two-drop driving waveform, a three-drop driving waveform, and a precursor driving waveform.

18. The liquid ejection apparatus according to claim 11, wherein
the signal processing circuit includes a first buffer in which the first waveform data is stored and a second buffer in which the second waveform data is stored.

19. The liquid ejection apparatus according to claim 18, wherein
the drive circuit and the signal processing circuit are integrated into a single integrated circuit.

20. The liquid ejection apparatus according to claim 11, wherein
the liquid ejection apparatus includes a printer,
the instruction is an instruction to print on the medium, and
each of the first and second waveform data is print data of a single line on the medium.
